(19) United States
(12) Patent Application Publication
(10) Pub. No.: US 2012/0188618 A1
(43) Pub. Date: Jul. 26, 2012

(54) OPTICAL INFORMATION REPRODUCING METHOD AND OPTICAL INFORMATION REPRODUCING APPARATUS

(76) Inventors: Toshiki ISHII, Yokohama (JP); Kenichi Shimada, Yokohama (JP)

(21) Appl. No.: 13/354,357

(22) Filed: Jan. 20, 2012

(30) Foreign Application Priority Data
Jan. 24, 2011 (JP) 2011-011511

(51) Int. Cl. G03H 1/02

(52) U.S. Cl. 359/3

(57) ABSTRACT

An optical information reproducing method and apparatus using an angle-multiplex recording type holographic memory. An optical information recording medium is exposed to a reference beam, the intensity of a diffracted beam diffracted in the medium is detected by a photodetector, an error signal is generated based on a value obtained by differentiating the detected intensity of the diffracted beam based on an angle of the reference beam, so that a reference beam angle control element is subjected to a feedback control.

### INCORPORATION BY REFERENCE

The present application claims priority from Japanese application JP2011-011511 filed on Jan. 24, 2011, the content of which is hereby incorporated by reference into this application.

### BACKGROUND OF THE INVENTION

The present invention relates to an apparatus and method for reproducing information from a recording medium, using holography.

Currently, based on Blu-ray Disc (BD) specifications using a blue-violet semiconductor laser, an optical disc having a recording density of as large as 50 GB may be commercialized even for consumer use. In the future, optical discs are desired to provide a large capacity comparable to the capacity of a HDD (hard disc drive) such as 100 GB to 1 TB.

However, in order to realize such an optical disc of ultra-high density, a high-density storage technology of a new scheme is required which is different from the conventional high-density technology which resorts to a shorter wavelength and a higher objective lens NA (numerical aperture).

During researches relating to a next-generation storage technology having been made, a holographic recording technology recording digital information using holography has been paid attention.

The holographic recording technology is defined such that a signal beam having information of page data two-dimensionally modulated by a spatial light modulator is superimposed on a reference beam within a recording medium, and a pattern of interference fringes resulting from the superimposition causes a modulation in the refraction index of the recording medium to thereby record the information on the recording medium.

When reproducing the information, the recording medium is exposed to the same reference beam as used in the recording. At this time, a hologram recorded in the recording medium functions as a diffraction grating to generate a diffracted beam. Thus, the diffracted beam is reproduced as the same beam as the recorded signal beam including phase information.

The reproduced signal beam is detected two-dimensionally at high speed using an optical detector such as a CMOS or CCD. In this manner, according to the holographic recording technology, by using one hologram, two-dimensional information can be recorded on the optical information recording medium at once and further the recorded information can be reproduced. In addition, the holographic recording technology allows a plurality of page data to be multiplex-recorded at the same position of the recording medium, thereby making it possible to effectively record and reproduce information of a large capacity at high speed.

Holographic recording technology is described, for example, in JPA-2004-272268 (U.S. Pat. No. 7,092,133). This publication discloses a so-called angle multiplexing recording system in which signal beam is converged on an optical information recording medium via a lens, and at the same time the recording medium is exposed to a reference beam as a parallel beam to interfere with signal beam, thereby performing holographic recording on the recording medium, and further a different page data is multiplex-recorded with an incidence angle of the reference beam to the optical recording medium being changed, by indicating the page data on a spatial light modulator. In addition, JP-A-2004-272268 discloses converging the signal beam via the lens and arranging the aperture (spatial filter) to the beam waist of the converged beam, so that the spacing between adjacent holograms may be made shorter to thereby increase the recording density and the storage capacity of the recording medium compared with the prior art angle-multiplexing recording system.

In an angle-multiplexing recording system, JP-A-2001-118253 discloses an example for controlling the incidence angle of a reference beam. In JP-A-2001-118253, a reading-out beam is applied to an optical recording medium on which a signal beam holding data information in a spatial polarization distribution is recorded by the reference beam in a hologram, to thereby read out a diffracted beam. The diffracted beam is detected as a detection signal. The exposure state of the reading-out beam to the optical recording medium is controlled based on the detection signal to thereby read out the data information from the diffracted beam.

### SUMMARY OF THE INVENTION

As described in JP-A-2001-118253, in a holographic memory of the angle multiplexing recording system, since Bragg selectivity is utilized, it is required to recover optical conditions of the reference beam used in recording with high precision when reading out data recorded on the recording medium. Optimum optical conditions may change due to a factor of thermal, mechanical and/or optical disturbance, so that a mechanism for compensating for the disturbance factor is required.

JP-A-2001-118253 utilizes two types of polarization to thereby record all of pixels as a bright part. In other words, by recording data based on a spatial polarization distribution, the intensity of a diffracted beam of the recorded data diffracted when exposed to a reading-out beam is kept constant. However, the prior art method is large in consumption of the recording medium compared with a system of recording data by two values consisting of a bright part and a dark part, thus raising a problem in realizing a large capacity of recording medium.

Further, in order to control the angle of reading-out beam so as to make the diffracted beam have an extreme value, a series of operations must be repeated which include setting the angle of reading-out beam, detecting the intensity of diffracted beam, comparing the detected intensity of diffracted beam with the intensity of diffracted beam stored in a control circuit, and again setting the angle of the reading-out beam according to a comparison result, so that a problem arises in making a high-speed operation.

The object of the present invention can be achieved by an exemplary solution which comprises exposing an optical information recording medium to a reference beam, detecting the intensity of a diffracted beam diffracted though the exposure using a photodetector, generating an error signal based on a value obtained by differentiating the intensity of a detected diffracted beam with the angle of the reference beam to apply a feedback control to a control element for the reference beam angle.

According to the present invention an incidence angle of the reference beam which is appropriate for reproduction can be detected with high precision and at high speed.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic block diagram of an optical information recording and reproducing apparatus according to one embodiment of the present invention.

FIG. 2 is an illustration showing an embodiment of a pickup within the optical information recording and reproducing apparatus.

FIG. 3 is an illustration showing another embodiment of a pickup within the optical information recording and reproducing apparatus.

FIGS. 4A to 4C are flow diagrams showing an embodiment of operation flow of the optical information recording and reproducing apparatus, respectively.

FIGS. 5A and 5B are graphs showing the relation between the reference beam angle and the intensity of diffracted beam, and the relation between the reference beam angle and the differentiated value of the intensity of diffracted beam, respectively.

FIG. 6 is an illustration showing configuration of servo control of the reference beam angle using the intensity of diffracted beam.

FIG. 7 is a schematic block diagram showing servo control of a galvanic mirror.

FIG. 8 is a schematic block diagram showing a servo control block of the reference beam angle using the intensity of diffracted beam.

FIG. 9 is a graph showing an aspect of control of the reference beam angle in Embodiment 1 of the present invention.

FIG. 10 is a graph showing an aspect of control of the reference beam angle in Embodiment 2 of the present invention.

FIG. 11 is a flow diagram showing operation flow according to the Embodiment 2.

FIG. 12 is an illustration showing the configuration of a pickup according to Embodiment 3 of the present invention.

### DESCRIPTION OF THE EMBODIMENTS

In the following, description will be made of the embodiments according to the present invention.

### Embodiment 1

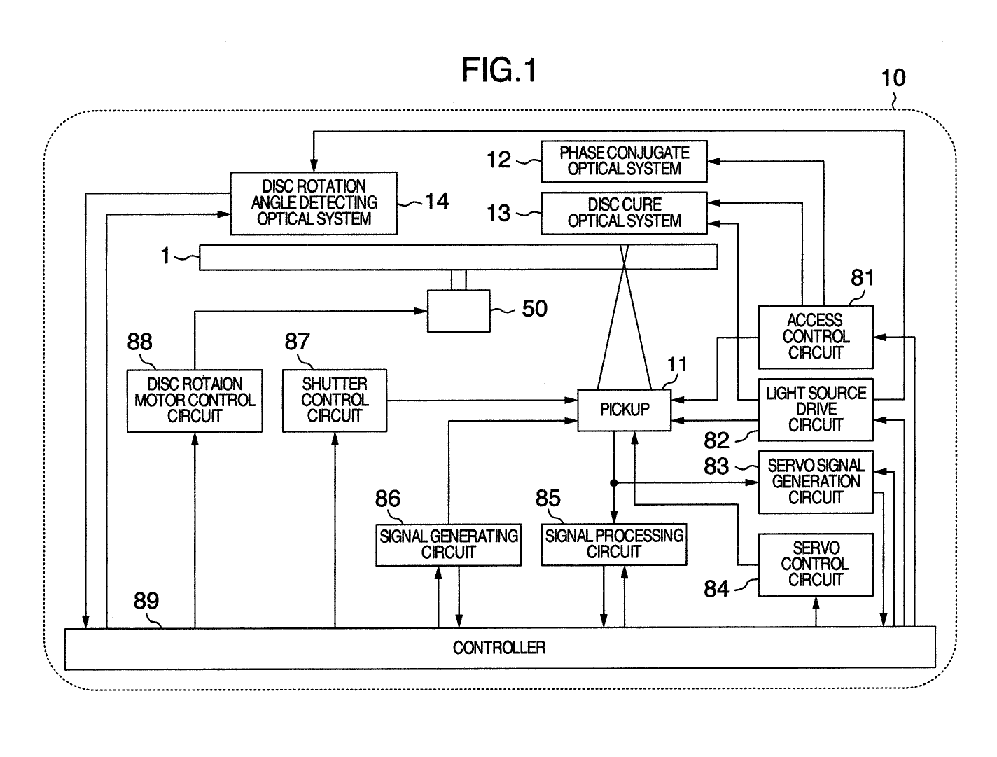

An embodiment of the present invention will now be described with reference to accompanying drawings. FIG. 1 shows in block diagram an optical information recording and reproducing apparatus which records and/or reproduces digital information utilizing holography.

An optical information recording and reproducing apparatus 10 includes a pickup 11, a phase conjugate optical system 12, a disc curing optical system 13, a disc rotating angle detecting optical system 14 and a rotating motor 50. An optical information recording medium 1 is configured to be rotatable by the rotating motor 50.

The pickup 11 plays a role of applying a reference beam and a signal beam to the optical information recording medium 1 and recording digital information on the recording medium 1 utilizing holography. At this time, the recorded digital information signal is sent to a spatial light modulator in the pickup 11 by a controller 89 through a signal generating circuit 86, and then the signal beam is modulated by the spatial light modulator.

When information recorded on the optical information recording medium 1 is reproduced the phase conjugate optical system 12 generates a phase conjugate beam of the reference beam emitted from the pickup 11. Here, the phase conjugate beam is defined to be an light wave which propagates in the direction opposite to that of an input beam with the same plane as the input beam being kept. A reproduced beam reproduced by the phase conjugate beam is detected by a photodetector which is to be described later and provided in the pickup 11, and then a signal is reproduced by a signal processing circuit 85 from the detected beam.

The exposure time of reference beam and signal beam to which the optical information recording medium 1 is exposed may be adjusted by controlling the on/off time of a shutter in the pickup 11 by the controller 89 through a shutter controlling circuit 87.

The disc curing optical system 13 plays a role to generate an optical beam to be used for pre-cure and post-cure of optical information recording medium 1. The pre-cure is defined as a pre-process of, when recording information on a desired position in the optical information recording medium 1, applying a predetermined optical beam to the desired position before applying the reference beam and signal beam to the desired position. The post-cure is defined as a post-process of applying a predetermined optical beam to a desired position in optical information recording medium 1 in order to prevent overwriting on the desired position after recording information thereon.

The disc rotating angle detecting optical system 14 is used to detect a rotating angle of the optical information recording medium 1. When adjusting the optical information recording medium 1 so as to have a predetermined rotation angle the disc rotation angle detecting optical system 14 detects a signal corresponding to a rotation angle, and the controller 89 can control the rotation angle of the recording medium 1 through a disc rotating motor controlling circuit 88 using the detected signal.

A light source drive circuit 82 feeds a predetermined light source driving current to light sources in the pickup 11, the disc curing optical system 13 and the disc rotation angle detecting optical system 14. Each of the light sources is capable of emitting an optical beam with a predetermined light quantity.

The pickup 11 and the disc curing optical system 13 each are provided with a mechanism for sliding its position in a radial direction of the optical information recording medium 1, so that the position control may be performed through an access control circuit 81.

Recording technology utilizing the principle of angle multiplexing of holography has a tendency that an error allowance to a shift or deviation of the reference beam angle becomes extremely small. It is therefore required to provide a mechanism for detecting the shift quantity of the reference beam angle in the pickup 11 and a servo mechanism associated therewith in the optical information recording and reproducing apparatus 10 so that a servo signal generating circuit 83 generates a signal for servo control and the shift quantity therein may be corrected through a servo control circuit 84.

The pickup 11, the disc curing optical system 13 and the disc rotation angle detecting optical system 14 may be simplified such that some or whole of them are configured into a single optical system structure.

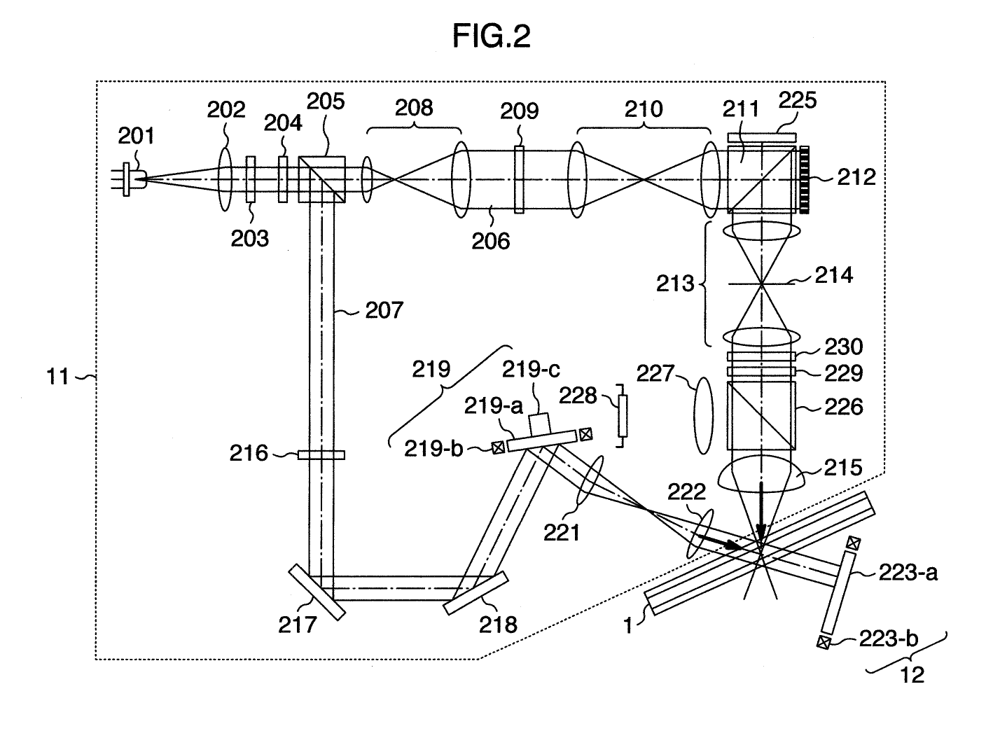

FIG. 2 shows a recording principle in an example of a basic optical system configuration of pickup 11 in the optical information recording and reproducing apparatus 10. An optical beam emitted from a light source 201 passes through a collimator lens 202 and becomes incident on a shutter 203. When the shutter 203 is open, the optical beam passes through the shutter 203 and thereafter is controlled relative to its polarizing direction by an optical element 204 formed of, for example, a half wavelength plate or the like such that the light quantity ratio between P-polarized optical beam and S-polarized optical beam may be a predetermined ratio, and then is incident on a PBS (Polarization Beam Splitter) prism 205.

The optical beam having passed through the PBS prism 205 serves as a signal beam 206, the optical beam is diametrically expanded by a beam expander 208, is passed through a phase mask 209, a relay lens 210 and a PBS prism 211, and is incident on a spatial light modulator 212.

The signal beam to which information is added by the spatial light modulator 212 is reflected in the PBS prism 211, and propagates in a relay lens 213 and a spatial filter 214. Thereafter, the signal beam is converged on the optical information recording medium 1 by an objective lens 215.

On the other hand, the optical beam reflected in the PBS prism 205 serves as a reference beam 207, is set in a polarized direction predetermined according to recording or reproducing by a polarizing direction converting element 216, and then is passed through a mirror 217 and a mirror 218 into a galvanic-mirror 219. The galvanic-mirror 219 is formed of a mirror 219-a and an actuator 219-b, and the actuator 219-b can adjust the angle of the mirror 219-a, so that the angle of the reference beam incident on the optical information recording medium 1 after passed through a lens 221 and a lens 222 can be set at a desired incidence angle. Here, in setting the incidence angle of the reference beam an element for converting the wave-front of reference beam may be used in place of the galvanic-mirror.

In this manner, the signal beam and the reference beam are entered so as to be superimposed on each other in optical information recording medium 1, so that an interference pattern is formed within the optical information recording medium 1. This pattern is written into the optical information recording medium to thus record information. The galvanic-mirror 219 can change the incidence angle of reference beam incident on the optical information recording medium 1, thereby making it possible to provide angle multiplexing recording.

Hereafter, in holograms recorded on the same area by changing the angle of the reference beam, a hologram corresponding to each angle of the reference beam is referred to as a page, and a set of pages angle-multiplexed on the same area is referred to as a book.

In adding data by the spatial light modulator 212, the intensity of diffracted beam of each reproduced page can be made substantially constant by modulating the data and keeping the ratio between the bright pixel and the dark pixel substantially constant.

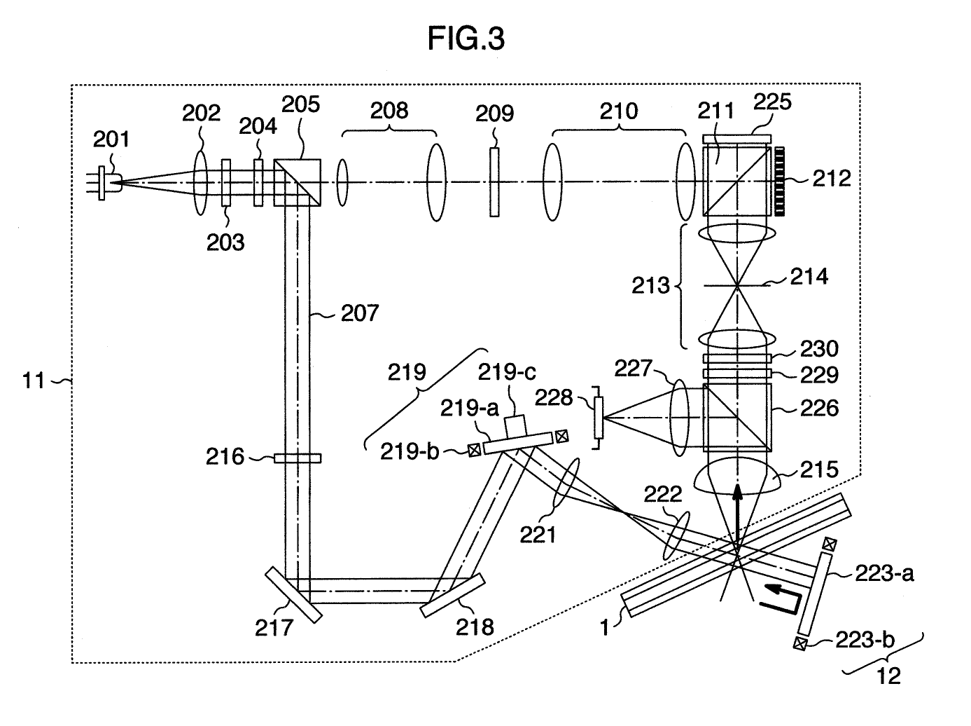

FIG. 3 shows a reproducing principle in an example of a basic optical system configuration of pickup 11 in the optical information recording and reproducing apparatus 10. Upon reproducing recorded information a reference beam is made to be incident on the optical information recording medium 1 as mentioned above, an optical passing through the recording medium 1 is reflected by the mirror 223-a of which the angle is adjustable by the actuator 223-b of a galvanic-mirror 223, to generate a phase conjugate beam thereof. In reproduction, the shutter 203 is kept always open to thereby control the incidence of diffracted beam to a photodetector 225 through a shutter 229.

A signal beam reproduced by the phase conjugate beam propagates in the objective lens 215, the PBS prism 226, the polarization direction converting element 230, the relay lens 213 and the spatial filter 214 when the shutter 229 is made open. After then, the signal beam passes through the PBS prism 211 and enters a photodetector 225 to allow the recorded signal to be reproduced. The photodetector 225 may be configured by using a pickup element which is typically CCD or CMOS.

The polarization direction control element 204 keeps the ratio of light quantity between P-polarization and S-polarization at a predetermined value, so that part of reproduced signal beam can be reflected by the PBS prism 226. The signal beam reflected by PBS prism 226 is converged by a lens 227, and is entered to a photodetector 228 to thereby detect the intensity of a diffracted beam. The diffracted beam from the photodetector 228 is reflected by the PBS prism 226 before entering the shutter 229, so always allowing monitoring. The photodetector 228 may not be CCD or CMOS, but may be, for example, a photodiode with which the optical pickup in the BD drive is provided for signal detection, so making it possible to expect that the quantity of light can be detected at high speed and the incidence angle at which the intensity of the diffracted beam is maximum can be detected fast.

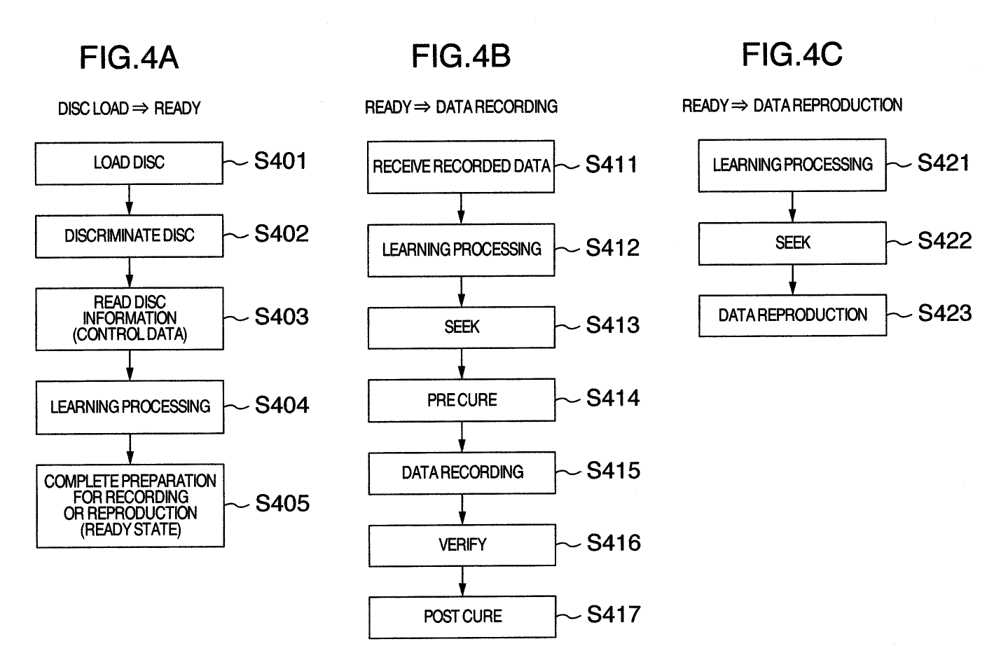

FIGS. 4A-4C show operation flows of recording and reproduction in optical information recording and reproducing apparatus 10. Particularly, flows concerning recording and reproduction utilizing holography will be described here.

FIG. 4A shows an operation flow of from loading of the optical information recording medium 1 on the optical information recording and reproducing apparatus 10 to completion of preparation for recording or reproducing. FIG. 4B shows an operation flow of from the preparation completion state to recording of information in the optical information recording medium 1, and FIG. 4C shows an operation flow of from the preparation completion state to reproducing of information recorded on the optical information recording medium 1.

When the recording medium is loaded on the optical information recording and reproducing apparatus 10 as shown in FIG. 4A (S401), the apparatus 10 discriminates a disc as the medium, for example, as to whether the loaded medium is a medium for recording or reproducing digital information utilizing holography (S402).

As a result of the disc discrimination, if it is determined that the medium is the optical information recording medium for recording or reproducing digital information utilizing holography, the optical information recording and reproducing apparatus 10 reads control data provided in the optical information recording medium (S403), and acquires, for example, information concerning the optical information recording medium and information on various kinds of setting conditions during recording or reproduction.

After the control data is read out, various adjustments corresponding to the control data and learning processings for pickup 11 are performed (S404), so that the optical information recording and reproducing apparatus 10 completes the preparation of recording or reproducing (S405).

As the operation flow of from the preparation completion state to recording of information is shown in FIG. 4B, first of all, a data to be recorded is received (S411), and information corresponding to the received data is sent to the spatial light modulator in the pickup 11.

After then in order to allow high quality information to be recorded on an optical information recording medium various kinds of learning processing is previously performed if required, (S412), and the pickup 11 and disc curing optical system 13 are disposed at predetermined positions of the optical information recording medium by a seek operation (S413).

After then, by using an optical beam emitted from the disc curing optical system 13, a predetermined area is pre-cured (S414), and a data is recorded by using a reference beam and a signal beam emitted from the pickup 11 (S415).

After the data is recorded the data is verified if required (S416) and a post cure is performed (S417) by using an optical beam emitted from the disc cure optical system 13.

As the operation flow of from the preparation completion state to reproduction of recorded information is shown in FIG. 4C, in order to allow high quality information to be reproduced from the optical information recording medium, various learning processings are previously performed if required (S421). Then, the pickup 11 and phase conjugate optical system 12 are disposed at predetermined positions of the optical information recording medium by a seek operation (S422).

After then, by making the pickup 11 emit reference beam, information recorded in the optical information recording medium is read (S423). The present invention is applied to the operation for reading the information.

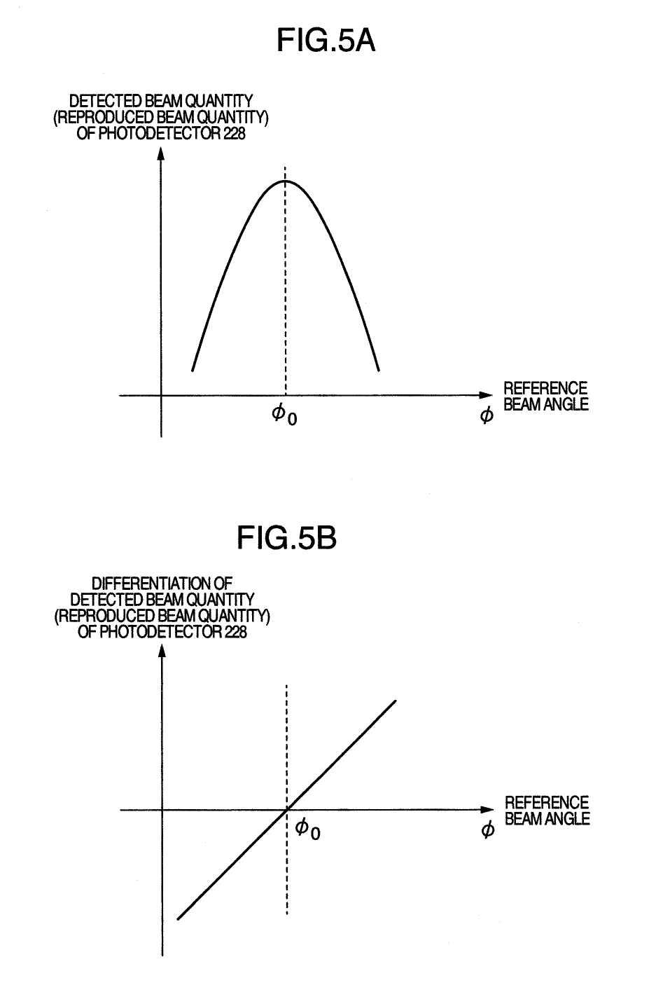

FIG. 5A schematically shows the relation between a reference beam angle and the intensity of a diffracted beam detected by the photodetector 228. Generally, the intensity of diffracted beam is maximum in the vicinity of a suitable reference beam angle φ₀ and decreases in accordance with the amount of deviation from φ₀. Therefore, the suitable reference beam angle can be set by controlling the reference beam angle so that the intensity of the diffracted beam may be substantially at maximum. In order to control the reference beam angle so as for the diffracted beam to be substantially at maximum, by utilizing that the value obtained by differentiating the intensity of the detected diffracted beam with respect to the reference beam angle is zero in the vicinity of φ₀ which exhibits, for example, a monotonously increasing straight line as shown FIG. 5B or curve, the reference beam angle may be controlled such that the obtained differentiation value may be in the vicinity of zero using the differentiation value as an index. Further, by using the differentiation value as an index, control is always possible to obtain a reference beam angle suitable for a relevant page even though the intensity of diffracted beam varies for every page. Generally, the reference beam angle at which the intensity of diffracted beam is at maximum approximately meets with the reference beam angle at which the quality of signal may be best. However, when it is found beforehand that these reference beam angles are not met, control may be made so as to offset by the difference between those reference beam angles.

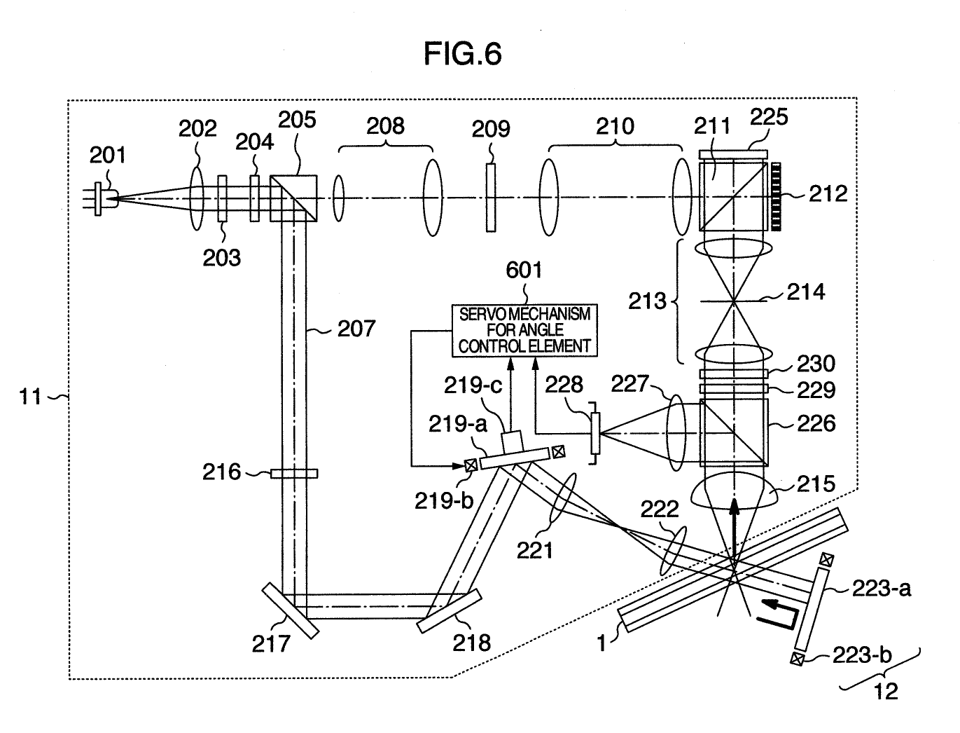

FIG. 6 illustrates a configuration for servo-controlling the reference beam angle by using the intensity of diffracted beam. A signal detected from the photodetector 228 is inputted to an angle control element servo mechanism 601, and a drive signal generated from the angle control element servo mechanism 601 is outputted to the actuator 219-b to thereby perform angle control of the reference beam. The actuator 223-b for driving a mirror 223-a for generating a phase conjugate beam is arranged to drive the mirror 223-a in interlocking with the angle of the mirror 219-a.

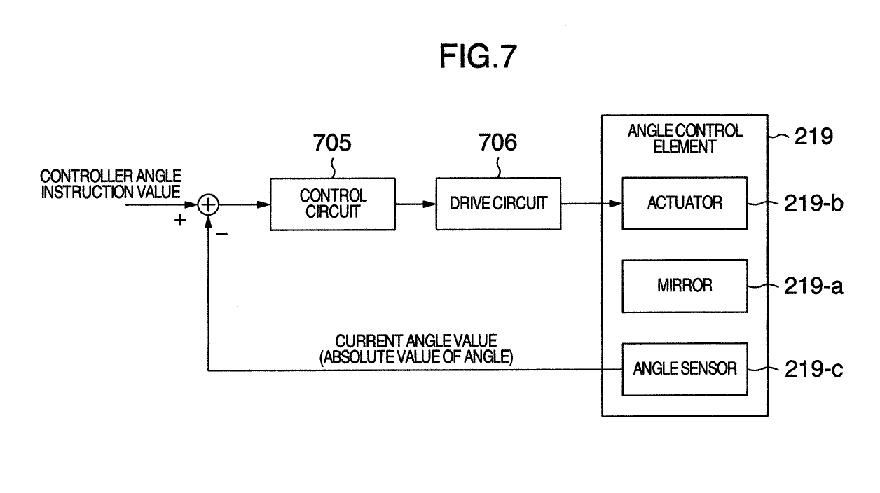

FIG. 7 shows in block diagram general configuration of a servo mechanism using a galvanic mirror as an angle control element. The galvanic mirror 219 includes the mirror 219-a, the actuator 219-b for driving the mirror and the angle sensor 219-c for detecting the angle of the mirror. The angle sensor 219-c outputs the angle of the mirror 219-a in absolute value. So, a differential between the absolute value of the mirror angle and an instruction value of the angle is taken out into a control circuit 705 as an error signal (referred to as an “angle sensor error signal” hereafter), and the actuator 219-b is driven by a drive circuit 706 based on a control quantity operated from the error signal, thus performing a feedback control. Such a configuration is useful when the instruction value of the angle is previously known, for example, as is the case of recording. However, when the suitable reference beam angle is deviated from that in recording as in reproduction to thereby require any compensation, the instruction value must be operated again based on a result of detection of diffracted beam, making high-speed control difficult.

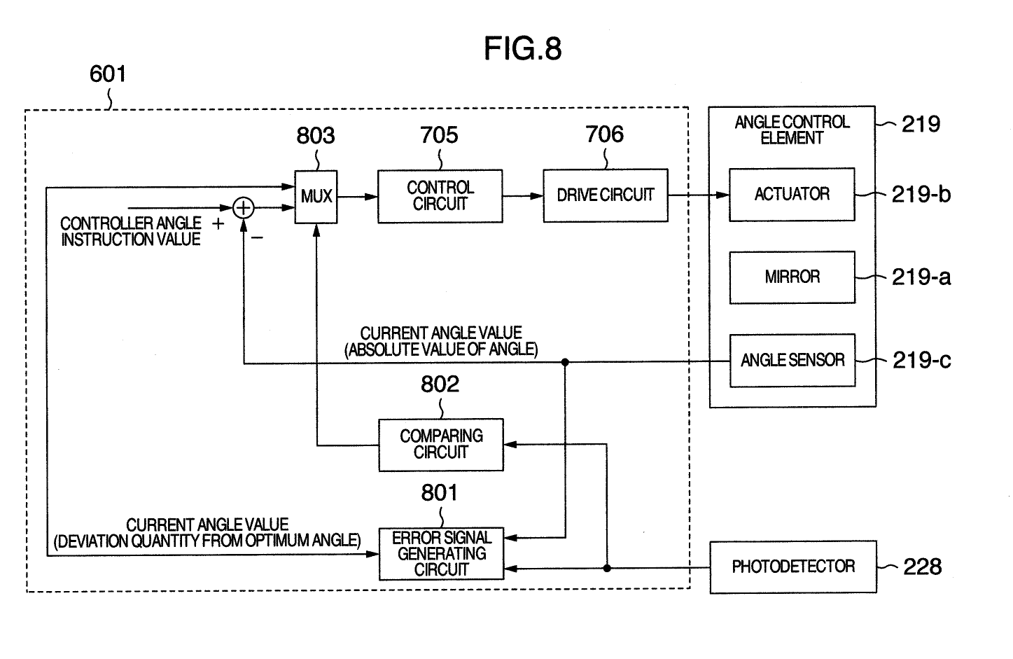

FIG. 8 shows in block diagram an example of the configuration of the angle control element servo mechanism 601 illustrated in FIG. 6. In FIG. 8, in addition to the configuration of FIG. 7, the servo mechanism 601 is configured to allow switching between the angle sensor error signal and an error signal generated from the angle sensor 219-c and the photodetector 228 (referred to as “diffracted beam error signal”). An error signal generating circuit 801 applies to the intensity of the diffracted beam detected by the photodetector 228 a differentiation operation based on the value from the angle sensor 219-c to thereby generate a diffracted beam error signal. The error signal generating circuit 801 may additionally and appropriately include a filter circuit to eliminate noise components and varying components in the intensity of the diffracted beam and/or a gain compensation circuit to combine the angle sensor error signal and sensitivity to thereby make it easy to use. The thus generated signal can be directly used as an error signal without requiring the instruction value, because as described in FIG. 5 when the signal quantity is controlled to be 0 the appropriate angle is nearly reached.

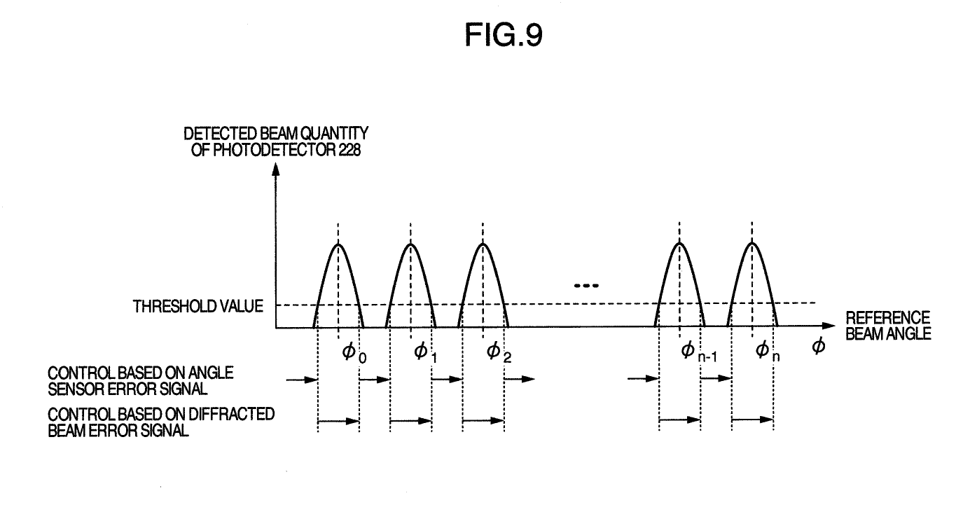

However, the diffracted beam will be generated only in the vicinity of an appropriate reference beam angle of each page, so that the diffracted beam error signal also can be utilized only in the vicinity of an appropriate reference beam angle of each page. For this reason, normally with control being made by the angle sensor error signal a comparing circuit 802 always monitors the intensity of the diffracted beam detected by the photodetector 228. When the monitored intensity of diffracted beam exceeds a voltage value corresponding to the intensity at which a diffracted beam error signal can be generated, a multiplexer 803 switches the control signal for the control circuit 705 from the angle sensor error signal to the diffracted beam error signal, thereby making it possible to control the reference beam angle at high speed and with high precision. FIG. 9 shows an aspect of switching between the diffracted beam error signal and the angle sensor error signal.

At the time when it could be determined that the quantity of error is sufficiently small after switched to the diffracted beam error signal, the shutter 229 is turned open, and the photodetector 225 detects a reproduction signal, and then subjects the detected signal to a reproduction signal processing. After it takes sufficient exposure time for obtaining the reproduction signal, the shutter 229 is closed and the processing proceeds to a reproduction operation of the next page.

In the present embodiment, in order to perform a differentiation operation based on the angle information the error signal generating circuit 801 uses an output value of the angle sensor 219-c. Alternatively, by minutely vibrating the actuator 219-b at high speed by a known amount of angle, taking out the output value of the photodetector 228 synchronously with the position at which the minute vibration is at maximum and minimum and applying a differentiation operation based on an amount of angle subjected to the minute vibration, the error signal generating circuit 801 may generate the error signal even without using the output value of the angle sensor.

According to the configuration of the present embodiment, the error signal is generated based on a value obtained by differentiating the intensity of the diffracted beam to thereby perform feedback control of the angle of reference beam, so taking an advantage that the angle of reference beam can be controlled at high speed and appropriately.

### Embodiment 2

In the present embodiment, description will be made of a method for acquiring a suitable angle of reference beam collectively before reproduction over all pages in a book. The description of an optical system in the present embodiment will be omitted because the optical system is common to those as in FIGS. 2 and 3.

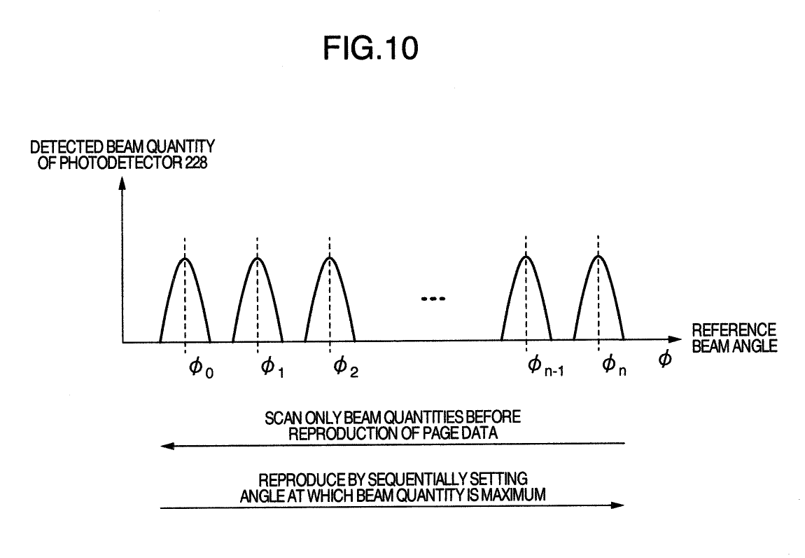

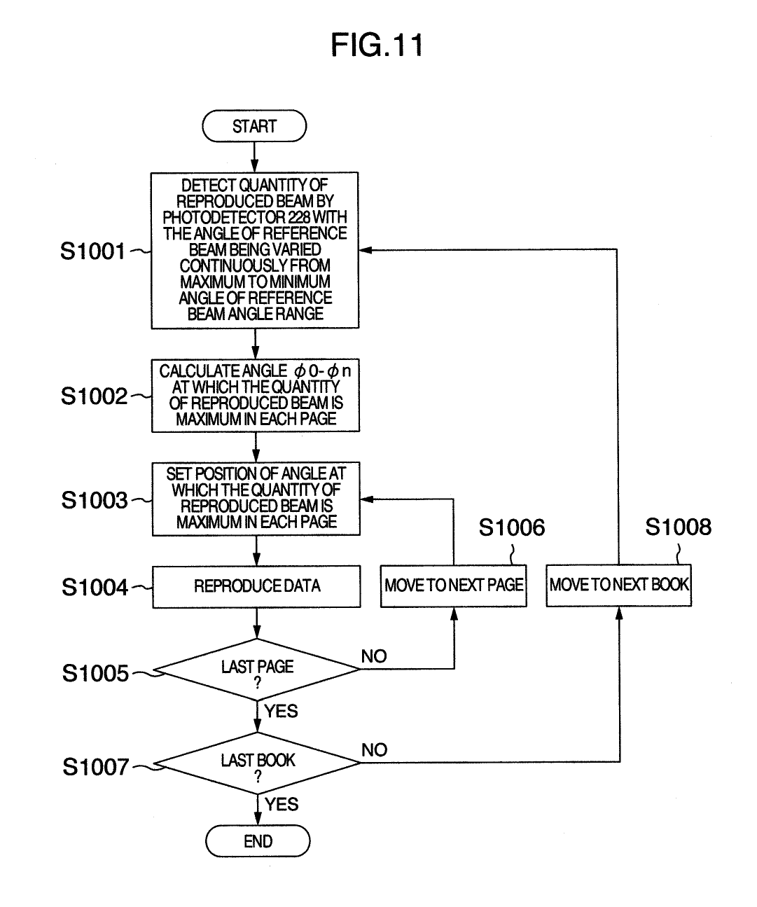

FIG. 10 shows an aspect of control of the reference beam angle according to the present embodiment. FIG. 11 shows an operation flow of angle scanning according to the present embodiment. Before reproduction of page data in the book, when the photodetector 228 detects the intensity of a diffracted beam with the angle of the reference beam being continuously scanned from the maximum angle to the minimum angle of an angle range within which the reference beam is multiplexed as to angle, waveforms with the maximum intensity of diffracted beam are acquired at suitable angle positions of diffracted beam of respective pages which have been angle-multiplexed, respectively (S1001). Next, the angle positions φ0-φn of the reference beam at which the intensity of diffracted beam is maximum in each page are calculated from the acquired waveforms (S1002). In the embodiment, for example, by using a differentiation operation a reference beam angle at which the differentiation value is 0 in each page can be regarded as a suitable reference beam angle. Subsequently, the reference beam angle at which the intensity of diffracted beam calculated in the step of S1002 is maximum is set sequentially in ascending order of from the minimum angle first (S1003) to thereby reproduce the data (S1004). Then, it is determined whether a reproduced page is the last page or not (S1005). If not the last page, the processing is set to proceed to the next page (S1006) and returns back to the step of S1003. On the other hand, if the last page, it is determined whether the processing is for the last book or not (S1007). If not the last book, the processing is set to proceed to the next book (S1008) and returns back to the step of S1001. On the other hand, if the last book, the reproduction operation is ended. Since the detection of the intensity of diffracted beam in the step of S1001 is different from the normal reproduction operation and makes angle scanning continuously, the detection of the intensity of diffracted beam can be ended by a time sufficiently shorter than the time required for reproduction of all pages. The increase in the processing time can be minimized by reversing the angle scanning direction for detecting the intensity of diffracted beam and the angle scanning direction for performing normal reproduction to each other.

In the description of the present embodiment, it has been described that the intensity of diffracted beam is scanned from the maximum angle of the reference beam angle toward the minimum angle thereof. However, the scanning may be carried out from the minimum angle toward the maximum angle. Further, the detection of diffracted beam is not carried out over all of pages, but it may be carried out for only pages required for reproduction.

According to the configuration of the present embodiment, because of not using the intensity of diffracted beam directly as the error signal, it is not necessary to configure a servo control circuit using the intensity of diffracted beam, therefore providing an advantage of realizing the invention in simple configuration.

### Embodiment 3

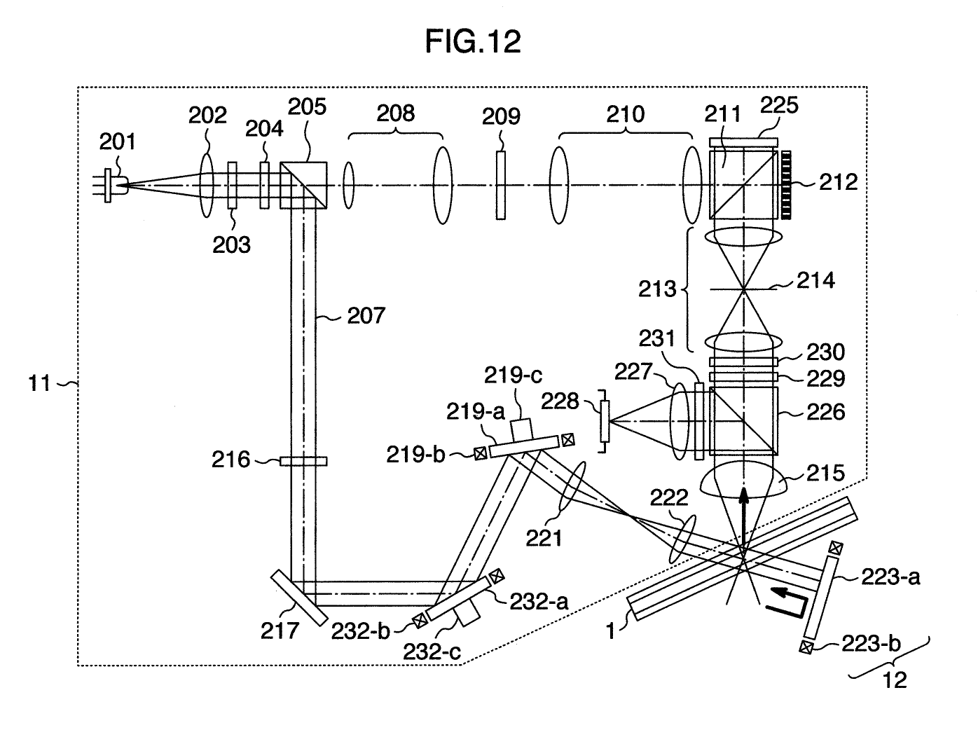

FIG. 12 shows the configuration of an optical system in the Embodiment 3. Compared with the configuration of FIG. 3 the mirror 218 is changed to an angle-variable mirror 232. The angle-variable mirror 232 includes a mirror 232-a and an actuator 232-b. The actuator 232-b makes the angle of mirror 232-a adjustable. In an example, as the angle-variable mirror 232 an MEMS mirror which is capable of high-speed driving though the angle scanning range is small compared with a galvanic mirror is used and can be operated in combination with the galvanic mirror. With such a configuration, the angle scanning range is made large, fast angle control is made possible and fast recording and reproduction can be realized.

The Embodiment 1 is configured such that the signal beam reflected by the PBS prism 226 is converged by the lens 227 and enters the photodetector 228 to detect the intensity of the diffracted beam. But, the present embodiment arranges an area-divided diffracting element 231 between the PBS prism 226 and the lens 227. With the area-divided diffractive element 231, a reproduced image is divided for each area and the divided image can be converged on the photodetector. Therefore, it is possible to detect the quantity of diffracted beam according to the area of the reproduced image. It is known that when the wavelength, the tilt of a disc or the like is changed the reference beam angle at which the intensity of diffracted beam is maximum is shifted with every area of the reproduced image. For this reason, by detecting the quantity of diffracted beam according to the area of the reproduced image, it is possible to not only determine the optimum reference beam angle, but also perform compensations for the wavelength and the tilt of disc, concurrently. The diffraction element 231 is preferably arranged at a position equivalent to an image plane of the reproduced image.

It should be further understood by those skilled in the art that although the foregoing description has been made on embodiments of the invention, the invention is not limited thereto and various changes and modifications may be made without departing from the spirit of the invention and the scope of the appended claims.

1. A reproducing apparatus for reproducing information from a medium on which an interference pattern is generated by a signal beam and a reference beam comprising:
a photodetector which detects the intensity of a beam diffracted by exposing the recording medium to the reference beam; and
an angle adjusting unit which adjusts an incidence angle of the reference beam to the recording medium based on information provided from the photodetector;
upon reproducing the information from the recording medium, the recording medium being exposed to the reference beam adjusted by the angle adjusting unit to thereby reproduce the information.

2. A reproducing apparatus according to claim 1, wherein the incidence angle of the reference beam is controlled so that the intensity of the diffracted beam may be substantially maximum.

3. A reproducing apparatus according to claim 1, wherein the incidence angle of the reference beam is controlled by offsetting a predetermined quantity from an angle at which the intensity of the diffracted beam may be substantially maximum.

4. A reproducing apparatus according to claim 1, wherein the incidence angle of the reference beam is feedback-controlled by using as an error signal a signal which is obtained by differentiating the intensity of the diffracted beam based on angle information from the angle adjusting unit.

5. A reproducing apparatus according to claim 1, wherein the intensity of the diffracted beam is monitored, and when the intensity of the diffracted beam exceeds a predetermined quantity, the incidence angle of the reference beam is controlled by switching the angle control of the reference beam from control based on angle information from the angle adjusting unit to control based on the intensity of the diffracted beam.

6. A reproducing apparatus according to claim 1, wherein the angle of the reference beam is scanned with the reference beam being applied before reproduction of a relevant book, the incidence angle of the diffracted beam is controlled based the intensity of the diffracted beam obtained by the exposure to reproduce the relevant book.

7. A method of controlling an incidence angle of a reference beam in a holographic memory apparatus for reproducing recording information recorded on a hologram recording medium as page data which is an interference pattern obtained by making the reference beam and a signal beam interfere with each other, comprising:
exposing a recorded area of the hologram recording medium to the reference beam;
detecting the intensity of a diffracted beam diffracted from the hologram recording medium; and
controlling an incidence angle of the reference beam based on the detected information of the intensity of diffracted beam.
